(19) United States
(12) Patent Application Publication
(10) Pub. No.: US 2010/0163623 A1
(43) Pub. Date: Jul. 1, 2010

(54) COLLOIDAL SUSPENSIONS

(76) Inventors: Ramos Mays, La Jolla, CA (US); Craig Herb, Medford, MA (US)

Correspondence Address: WILSON, SONSINI, GOODRICH & ROSATI, 650 PAGE MILL ROAD, PALO ALTO, CA, 94304-1050, US

(21) Appl. No.: 12/442,704

(22) PCT Filed: Sep. 25, 2007
(86) PCT No.: PCT/US2007/079446

§ 371 Date: Nov. 30, 2009

Related U.S. Application Data
(60) Provisional application No. 60/827,398, filed on Sep. 28, 2006.

(51) Int. Cl. G06K 7/10; C09D 11/00; C09D 11/10; B32B 3/10

(52) U.S. Cl. 235/462.01; 106/31.13; 524/408; 524/556; 428/195.1

(57) ABSTRACT

Presented are compositions that when applied in a spatial manner so as to encode information, can remotely detected. Such compositions have liquid properties that make them adaptable to delivery by means such as a jet or needle injector. Instant compositions comprise a particulate material, a suspending agent, and a dispersing agent. Also taught are readable codes made by such compositions, and methods of applying such compositions. Other uses of such compositions are also taught

### CROSS-REFERENCE TO RELATED APPLICATIONS

This application claims the benefit of U.S. Provisional Application Ser. No. 60/827,398 filed 28 Sep. 2006; hereby incorporated by reference herein in its entirety,

### TECHNICAL FIELD

Described herein are compositions of a particulate material useful for application in an information-storing pattern.

### BACKGROUND

Today uniform product code (UPC) labels are on practically every product produced in the world. Optical barcodes have become so widely accepted because of their low production costs, device complexity, and high durability. These same properties which caused their success now limit their usefulness in commercial applications. The simple design has low production costs, but is severely limited in the amount of data it can represent. The design also allows for simple and cheap detection through optical reading systems. However, optical reading systems require a direct, unobstructed path for light to be emitted onto the barcode and then reflected back to the sensor. This unobstructed (i.e., “line-of-sight”) property of optical read barcodes limits their usefulness. For example, to conduct inventory management, objects must be placed in a specific physical location for their identification information to be read.

To combat the “line-of-sight” problem posed by traditional barcodes, radio-frequency identification solutions have been developed. Radio-Frequency Identification (RFID) tags store and transmit identification information that is similar to the information stored in barcodes. A RFID system consists of an interrogation device that broadcasts a radio signal and a RFID tag which receives said radio signal. With a passive RFID tag, the radio signal power itself is used to power-up a small microchip within the tag, which then transmits its unique identification code back to the interrogation device. The radio waves used to interrogate RFID tags for can pass through many materials, therefore solving the “line-of-sight” issue present in optically read barcodes.

RFID technology does, however, have its own problems. RFID tags can be divided into two major categories: active and passive. Active RFID tags contain their own power source which increases the distance in which it can provide identification information. Problems with this type of tag include cost of production due to the complexity of such a device as well as maintenance issues, physical size and weight constraints, and power consumption. Passive tags overcome cost and complexity issues, but in turn have greatly restricted operability and flexibility. Because a microchip is embedded in an RFID tag, along with radio frequency receivers, power supply, data memory, and transmitters, the device complexity and associated cost is much higher than that of optical barcodes.

### SUMMARY OF THE INVENTION

New compositions have been discovered that, when applied in a pattern (e.g. the “readable code”), deposit information that is capable of remote identification (i.e. “remotely reading the code”). Such compositions have liquid properties that make them adaptable to delivery (e.g. application) by means such as a jet or microneedle injector. Instant compositions comprise a particulate material, a suspending agent, and a dispersing agent. Also taught are readable codes made by such compositions and methods of applying such compositions.

Described herein are colloidal suspensions that are used to mark objects. In one embodiment, the mark is placed on the surface of the object or within the surface of the object or under the surface of the object. In one embodiment, the mark is read with microwave and/or millimeter wave radiation. In one embodiment, the mark on the object is used to provide information, including information about the object, such as the identification of the object. In one embodiment, the mark is in the form of a two-dimensional image or a three-dimensional image. In one embodiment, the mark is produced from a single type of colloidal suspension or from multiple types of colloidal suspension. In one embodiment, the mark is in the form of a barcode, another form of code, an image, or a hologram. In one embodiment, the mark on the object is a permanent mark, a semi-permanent mark, a mark that wears off or washes off, or a readily removable mark.

In another aspect are compositions prepared by the aforementioned methods. In a further or alternative embodiment, the composition is suitable for applying on or into at least a portion of a surface. In a further or alternative embodiment, the composition dries within one hour of application on at least a portion of a surface. In a further or alternative embodiment, the composition is used for intradermal application.

In another aspect are surfaces or objects comprising any of the aforementioned compositions. In a further or alternative embodiment, the composition is on or within the surface of the object. In a further or alternative embodiment, the object is a glass object, a plastic object or a metal object. In a further or alternative embodiment, the object is a paper object. In a further or alternative embodiment, the object is a cardboard object. In a further or alternative embodiment, the object is an animal. In a further or alternative embodiment, the animal is a farm animal or laboratory animal. In a further or alternative embodiment, the farm animal is equine, bovine porcine or ovine.

In another aspect are uses of any of the aforementioned compositions, in which the compositions are used to provide an information-containing pattern detectable by remote interrogation. In a further or alternative embodiment, the information-containing pattern is a bar code. In a further or alternative embodiment, the information-containing pattern is a hologram.

### CERTAIN DEFINITIONS

As used herein, the following definitions apply:

“Biocompatible” means in the amounts employed, the composition is non-toxic or substantially biologically and chemically unreactive in a living system or does not elicit any substantial detrimental response in the living system.

“Dispersing agent” means an agent that promotes dispersion of the particulate material during processing (e.g. formulation) and/or that retards particle aggregation during storage and use of the composition when compared to a similar composition that substitutes water for a dispersing agent.

“Examplary” as it is used in reference to embodiments, means a non-limiting example that demonstrates or illustrates technical features, the scope of which are also non-limiting.

“Freeze-thaw resistant” means that after three freeze/thaw cycles, the composition retains one or more technical features of the invention.

A “dispersing concentration” means a concentration of a dispersing agent effective to promote particle dispersion and/or to retard particle aggregation.

“Instant” as it may be used in reference to a composition, use, component or technical feature, is meant to refer to the invention or a component thereof first disclosed herein.

A “particle size upper limit” means that in a composition, 98% of the particles by mass are smaller than the stated limit.

“Readable code” (or “code”) shall be used to mean any pattern that is remotely identifiable (e.g. distinguishable from a code of a different pattern). Used in this way, “code: is a noun that contains readable information or identification (e.g. a bar code).

“Suspending agent” means an agent that retards the settling velocity compared to a similar composition that substitutes water for a suspending agent

A “suspending concentration” means a concentration of a suspending agent that retards the settling velocity of a composition.

“% V/V” means volume per 100 volume. Unless otherwise indicated, the denominator is volume of the composition.

“% W/W” means weight per 100 weight. Unless otherwise indicated, the denominator is weight of the carrier medium.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 presents an illustrative plot of Reflection Vs. Refraction Coefficient.

FIG. 2 shows a typical frequency dependence of dielectric constant vs. frequency in solid materials.

FIG. 3 presents an illustrative particle size analysis of sodium potassium niobate (NKN) Na_{0.5}K_{0.5}NbO₃ prepared as described herein.

FIG. 4 presents an illustrative X-Ray Diffraction (XRD) analysis of sodium potassium niobate (NKN) Na_{0.5}K_{0.5}NbO₃ prepared as described herein.

FIG. 5 presents illustrative SEM images of sodium potassium niobate (NKN) Na_{0.5}K_{0.5}NbO₃ after sintering at 1050° C. for 1 hr, at various resolutions.

FIG. 6 presents illustrative SEM images of sodium potassium niobate (NKN) Na_{0.5}K_{0.5}NbO₃ after sintering at 1050° C. for 16 hr, at various resolutions.

FIG. 7 presents an illustrative, non-limiting example of the preparation of sodium potassium niobate particles, including preparation and analysis of samples.

### DETAILED DESCRIPTION OF THE INVENTION

A problem with RFID technology is the separation between an object and its identification information. An object is not directly identifiable relative to a barcode embedded directly on the object itself A tag is affixed to the object, therefore causing all relevant data to be associated with not the object itself, but with a tag on the object. If a tag becomes separated from the object the identity of that object is lost.

One example of the problems associated with data separation caused by RFID technology can be seen in the field of livestock tracking. Since the advent of RFID solutions, the agriculture industry has been attempting to utilize this technology for means of animal identification in the form of a RFID tag affixed to an ear tag placed on the animal. Studies have shown that approximately 10% of ear tags become separated from the animal throughout its life cycle either by accidental separation, or through human removal. If data relative to an animal is associated with a RFID tag, and the tag becomes separated from the animal all data associated with that animal is also lost. Thus, with RFID technology, information is related not to the object itself, but to a tag which is then associated with the object. This three party identification solution is more complex than a direct identification solution, and is therefore less reliable and less permanent.

U.S. Pat. Nos. 7,180,304; 7,205,774; and 7,221,168 describe a microwave readable dielectric barcode formed from particles of high dielectric constant; such a barcode can be read by an interrogating microwave signal. One application of such a barcode is animal labeling by inserting the barcode beneath the skin layer of an animal. Such “tattooing” or subcutaneous insertion of a barcode avoids the problems associated with the loss of an RFID tag by an animal.

Described herein are compositions that provide a convenient means to create a remotely readable code. For example, compositions are described that are applied by various means such as injection or spraying. Also described herein are compositions that are ready-mixed, temperature tolerant, and shelf stable yet with rheological properties that make it deliverable through needles or jets (e.g. pressure-driven orifice). Also described herein are compositions that are injected into and read through the thick hide of an animal covered with hair, fleece, mud, and the like. Described herein are compositions that scatter microwave radiation, and the use of such compositions to mark substrates (living or non-living), either on the surface of the substrate or within the substrate itself.

### Compositions and Methodologies

The compositions described herein comprise solid particulate matter suspended in a suitable carrier medium. In a further embodiment, compositions are directed to use on or within animals, the carrier medium is biocompatible. However, for uses not directed to the marking of animals, the carrier medium can be non-biocompatible. At least one of the solid particulates within the composition is a dielectric material.

### Compositions

An example of a composition that is used for the applications described herein comprises a carrier medium and a particulate material, where the carrier medium comprises
(a) a suspending concentration of a suspending agent; optionally about 0.01% to about 10% or about 0.25% to about 1.5% or about 0.25% to about 1% (W/W);
(b) a dispersing concentration of a dispersing agent; and optionally
(c) one of one or more excipients,
wherein the particulate material:
   (i) is suspended in the carrier medium;
   (ii) has a dielectric constant of greater than 35 at one or more frequencies between about 10 GHz and about 1000 GHz at about 37° C.;
   (iii) has a mass average diameter of about 200 nm to about 50 μm and optionally where the upper limit is not more than about 100 μm in diameter, and
   (iv) has a concentration of about 1% to about 50%; optionally about 2% to about 30% or about 4% to about 16% (v/v).

Optionally, (a) the composition is biocompatible; (b) the carrier medium further comprises a preservative agent; (c) the composition is pasteurized; and/or (d) the suspending agent is a polymer and the carrier medium further comprises a polymer stabilizer

Compositions of described herein are injectable. By way of example are injectable compositions having one or more desired technical features, for example 2 or 3 or 4 or more of the following features:
(i) an apparent viscosity of about less than about 0.5 Pa second at a shear rate of about 10,000 seconds⁻¹, or optionally has as an apparent viscosity of less than about 0.1 Pa seconds at a shear rate of about 10,000 seconds⁻¹;
(ii) a yield stress of at least about 0.05 Pa, or optionally has a yield stress of at least about 1 Pa;
(iii) an apparent viscosity greater than about 3 kPa seconds at an applied shear stress of about 0.25 Pa or less for about 10 μm upper particle size, or optionally, greater than about 75 kPa seconds at an applied shear stress of about 1.2 Pa or less for a about 50 μm upper particle size; or optionally an apparent viscosity greater than 30 kPa seconds at an applied shear stress of about 0.25 Pa or less for a about 10 μm upper particle size, or optionally, greater than about 750 kPa seconds at an applied shear stress of about 1.2 Pa or less for about 50 μm upper particle size;
(iv) a settling velocity of less than about 2 mm/year or less than about 0.2 mm/year.

Described herein are methods for formulating insoluble particulate material in a homogeneous suspension which is stable with respect to particle distribution and resistant to aggregation yet having desired rheological properties that allow delivery through an orifice such as in a microneedle or a spraying orifice (e.g. ink jet).

The instant compositions unexpectedly provide for extended shelf life, e.g. 3 months or 6 months or one or more years. By shelf life, it is meant a period of time where the technical features of the disclosed compositions (e.g., the colloidal suspensions described herein) are preserved during storage.

Optionally, instant compositions demonstrate resistance to freeze-thawing—by resistance it is meant that one or more technical features of the disclosed compositions (e.g., the colloidal suspensions described herein) are preserved following one or more freeze/thaw cycles. A suspension of the particulate material is prepared such that the desired rheological properties are achieved and maintained even though such particulate material otherwise has a tendency to agglomerate during freezing. Without being bound by theory, interactions occur between the particulate material and one or more of the carrier medium, suspending agent, and dispersant that keep the particulate material dispersed during freezing.

Optionally, the instant compositions are biocompatible. Optionally, each component of an instant composition, at the concentrations present, are compatible with the skin of a mammal as evidenced by the lack of any moderate to severe skin irritation.

In further embodiments, the instant compositions (a) do not contain polysiloxane; (b) do not contain a plasticizer; (c) do not contain magnetic particles; (d) have a domain size greater than 100 nanometers; (e) do not contain an organic solvent; or (f) any combination of the foregoing.

### Particulate Material

Technical features have been discovered that contribute towards a superior remote detection. For example, particulate material useful in instant compositions has a dielectric permittivity above 35 and are selected from dielectric, magnetic, piezoelectric, metal and metal oxide particulate material. Non limiting examples of such materials are quartz and ferroelectric or perovskite materials.

In one embodiment the particulate material described herein as a dielectric material that is highly resistant to electric current, and as such tend to concentrate an applied electric field (e-field) within themselves. Dielectric materials can be solids, liquids, or gases, though solids are the most commonly used dielectrics. Some non-limiting examples of dielectric materials include ceramics, porcelain, glass, mineral oil and most plastics, and their uses include though are not limited to industrial coatings, electrical transformers and high voltage capacitors. Many dielectrics also demonstrate piezoelectric properties (the ability to generate a potential difference when subjected to mechanical stress, or change physical shape when an external voltage is applied across the material) and/or ferroelectric properties (exhibit a spontaneous dipole moment reversible by an externally applied electric field).

In some embodiments the particulate material has a Perovskite structure. Perovskites are a large family of crystalline ceramics that derive their name from a specific mineral known as perovskite (CaTiO₃) due to their crystalline structure. The mineral perovskite typically exhibits a crystal lattice that appears cubic, though it is actually orthorhombic in symmetry due to a slight distortion of the structure. Members of the class of ceramics dubbed perovskites all exhibit a structure that is similar to the mineral of the same name. The idealized structure is a primitive cube, with the A cation located in the middle of the cube, B on the corners, and the oxygens on the centers of the unit cell faces.

The characteristic chemical formula of a perovskite ceramic is ABO₃, where A and B are different cations of different sizes, and typically A is mono- or divalent and B is tetra- or pentavalent. Simple examples include LaMnO₃, BaTiO₃, CaTiO₃, MgSiO₃, CaZrO₃, YAlO₃, SrTiO₃, KNbO₃, LiNbO₃, LiTaO₃, BiFeO₃, SrCeO₃ and ScAlO₃.

Slightly more complex examples exist whereby the A cation is in fact composed of two different cations, so the formula becomes XₙY_{1-N}BO₃, (i.e. X and Y together make A, e.g. Sr_{0.5}Ca_{0.5}Ru₃, where x=0.5), such that the ratio A:B:O is still 1:1:3 (or (X+Y):B:O=1:1:3). Similarly, In one embodiment, the B cation is composed of two different cations, as in lead zirconate titanate (PZT) which has a formula PbZr₁₋ₓTiₓO₃, and exists in many forms (e.g. Zr_{0.65}Ti_{0.35}PbO₃).

Perovskites are useful, versatile compounds having many technological applications such as sensors, superconductors, catalysts and in particular ferroelectrics as advanced electronic materials useful in applications such as memory devices, resonators and filters, infrared sensors, microelectromechanical systems, and optical waveguides and modulators. Among the perovskite-structured ferroelectric materials, sodium potassium niobate, NaₓK₁₋ₓNbO₃ (“NKN”) is a useful material in radio frequency (rf) and microwave applications due to its high dielectric tenability and low dielectric loss.

Optionally, in any of the aforementioned embodiments, the instant particulate materials are biocompatible. See, e.g., U.S. Pat. No. 6,526,984, issued Mar. 4, 2003 and titled “Biocompatible Material for Implants” that discloses a biocompatible ceramic NaₓK₁₋ₓNbO₃.

### Dielectric Permittivity

The instant compositions are useful for forming a code “readable” by, for example, the technology taught in U.S. Pat. No. 7,180,304. In one embodiment, the ability of a bar codes described herein to be detected is estimated by considering the dielectric permittivity of the bar code. The dielectric's permittivity (“∈”) characterizes the response of a ferroelectric when subjected to an external electromagnetic signal. It is defined as “incremental” dielectric permittivity.

$${ɛ}_{r} = \frac{\partial P}{\partial E}$$

Where P=polarization and E=the external electromagnetic field.

The permittivity of a particulate material described herein is determined by its dielectric constant, ∈ᵣ, and its index of refraction, n.

Since reflection R is the absolute value of the reflection coefficient we now have

$$R = \vert {Γ}_{1} \vert = \frac{\sqrt{{ɛ}_{r}} - 1}{\sqrt{{ɛ}_{r}} + 1}$$

Thus, the refraction index is equal to the square root of our relative permittivity so we get

$$R = \frac{n - 1}{n + 1}$$

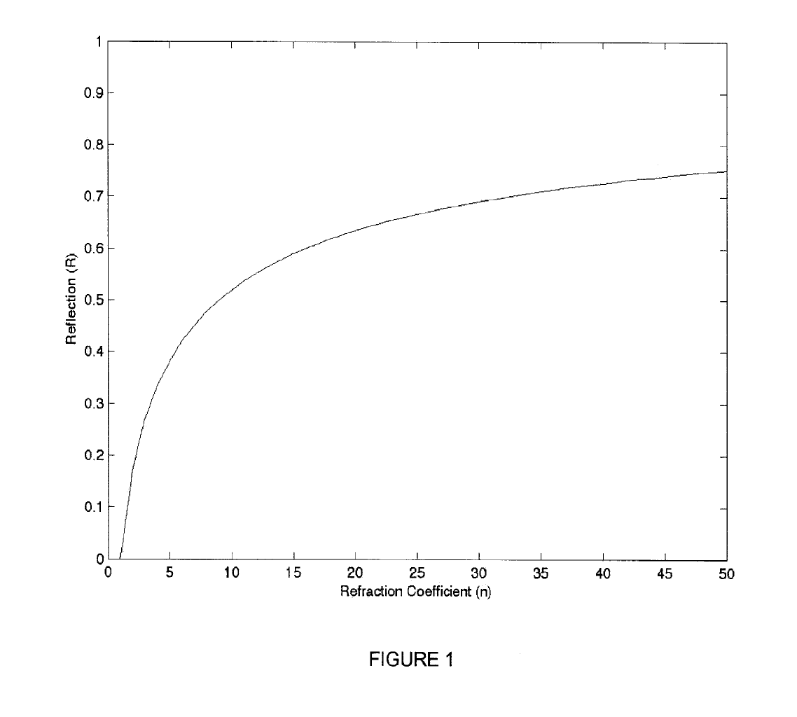

As n approaches positive infinity, we find that for large refraction indexes we obtain saturation of the reflected wave as shown in FIG. 1.

This graph shows us that to obtain the largest possible reflection coefficient we need to reflect the incident with a very high ∈. Potassium sodium niobate has a dielectric permittivity approaching 1200 which gives a refraction coefficient of 35. This value is sufficient to obtain reflection levels near saturation. Other materials having a high dielectric constant are useful in the methods and compositions described herein.

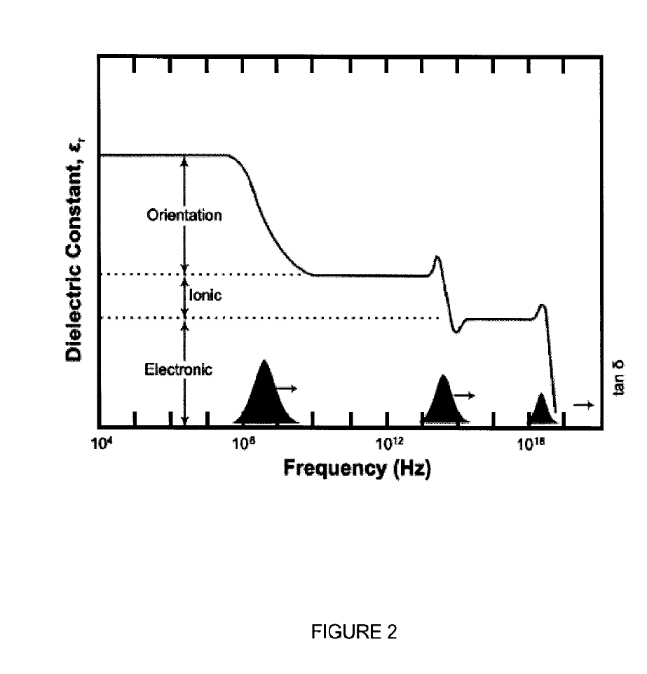

Dielectric permittivity decreases as frequency increases and typical frequency dependence is presented in FIG. 2. Because of this well-known law of dielectrics, it was expected initially that electromagnetic radiation at high enough frequencies to decode a pattern would cause such low relative permittivity in these materials that they would be unreflective and therefore unusable. However, we have found that materials such as Sodium Potassium Niobate and PZT have such high permittivities that they retain a high enough refractive index to reflect electromagnetic radiation even at very small wavelengths. This discovery has made a dielectric readable barcode feasible.

### Size Range

One of the many problems in the art that needed to be overcome was to discover a range of useful particle sizes that would simultaneously meet several required technical features. For example, if the particle size is too small, the particulate material will have the adverse property of fluid migration—that is, tendency to migrate after deposition in or on a substrate. In one embodiment, present compositions do not contain a substantial portion of particulate material below about 1,000 nm or about 500 nm or about 300 nm or about 200 nm.

On the other hand, as the particles become very large (e.g. greater than 10 μm in diameter), the particulate matter has a greater tendency to present delivery problems; for example, clogging needles/or orifices. Even, less large particles require a high yield stress to prevent such material from settling. Taken together, it is now surprising that the particulate material is supplied in a size range that allows formulation into a composition which exceeds the requirements for a useful product.

Examplary mass average ranges of particle sizes of particulate material are between about 0.1 μm to about 50 μm or about 1 μm to about 20 μm or an average of about 5 μm.

As the upper particle size of the distribution becomes larger, the largest particles exert a greater stress on the carrier medium, requiring the composition to provide a higher yield stress, or optionally to provide a higher apparent viscosity at this greater stress, in order to prevent them from settling during storage. Such changes in the formulation often tend to also cause an increase in the apparent viscosity at the high shear rate range, which can increase the required driving pressure during the delivery of the formulation during use.

### Methods of Preparation

Methods of producing particle sizes and distributions useful in the methods and compositions described herein include: physical means (e.g. ball milling, wet milling, dry milling, sieving, etc.) to produce appropriate particles; calcining, i.e. the process of heating a substance to a high temperature, to bring about thermal decomposition or a phase transition in its physical or chemical constitution; or combinations thereof.

By way of example, instant particles of sodium potassium niobate are be prepared by the steps comprising: (a) forming a mixture by contacting: (i) sodium carbonate; (ii) potassium carbonate; (iii) niobium (V) oxide; and (iv) an alcohol; (b) ball milling the mixture of step (a); (c) air drying the mixture of step (b); (d) sieving the mixture of step (c); (e) heating the mixture of step (d); (f) ball milling the mixture of step (e); (g) air drying the mixture of step (f); and (h) sieving the mixture of step (g) to isolate particles having an average diameter of from about 500 nm to about 10 μm.

Optionally, (i) the alcohol from step a above is ethanol; (ii) the molar ratio of sodium carbonate to potassium carbonate to niobium (V) oxide is 1 to 1 to 2; (iii) the weight ratio of solids to alcohol is from about 0.5:2 to about 2:0.5; (iv) the ball milling of steps (b) and (f) occurs for at least 8 hours; (v) the ball milling of steps (b) and (f) utilizes zirconia balls; (vi) the zirconia balls have a diameter of from about 0.1 to about 0.5 inches; (vii) the heating of step (e) occurs at a temperature of at least 900° C.; and/or (viii) the heating of step (e) occurs for at least 30 minutes.

The particle size distribution of the particulate material is dependant, in part, on the method of preparation. In one embodiment, the particle size distribution of the particulate material is determined before its incorporation into the composition using techniques such as laser diffraction and/or light scattering instruments, photozone or light blocking instruments, sedimentation rate or disk centrifugation, electrozone instruments (Coulter Counter), acoustic attenuation and scattering, optical or electron microscopy with or without image analysis software.

The particle size distribution can be monomodal, bimodal, trimodal, multimodal; each mode can be gaussian in distribution or non-gaussian in distribution

### Concentrations

Particulate material of instant compositions is present in a concentration sufficient for remote detection yet at a concentration that provides for the necessary fluid properties. Examplary concentrations are about 1% to 50% or about 2% to about 30%, or about 4% to 16% (V/V). Optionally, instant compositions do not demonstrate shear thickening—a property that could lead to clogging of the delivery system in use. As the concentration of the dispersion exceeds about 30 volume percent, the tendency increases for compositions to become shear thickening at the shear rates imposed in the delivery device during use. Such behavior can lead to clogging of the device even when all the particles are small enough to pass through the device, but, in certain embodiments, is avoided through modifications of the delivery device dimensions, geometry, and rate of delivery

Generally, as the concentration of the particulate material increases, the concentration of the suspending and/or dispersing agent also needs to be altered By way of example, instant compositions of the following groups have desirable technical features.

TABLE 1

| | Suspending Agent | Dispersing Agent |
|---|---|---|
| Particulate Material | (% W/W), e.g., Carbopol | (% W/W) e.g., |
| (% V/V of composition) | or Kelcogel | Darvan C-N |
| 0%-10% | 0.02%-5% | 0.00%-0.2% |
| 10%-20% | 0.02%-5% | 0.05%-0.4% |
| 20%-40% | 0.02%-5% | 0.10%-0.8% |
| 40%-80% | 0.02%-5% | 0.20%-1.6% |

### Suspending Agent.

Unexpectedly the compositions described herein are stable suspensions of insoluble particles; i.e. the change in distribution of the particles with time (e.g. settling velocity) is unexpectedly retarded. For example, in some embodiments, diffusion and settling of the particles are reduced to the point of being insignificant over the desired shelf life of the composition.

It is a desired property of instant compositions that the particulate material does not settle even after long periods of standing, for example days or weeks or months or longer. However, in certain embodiments, the viscosity of a composition is elevated to a level that keeps the particulate material in useful sized particles from settling, but at the same time, provides for fluid properties sufficient to allow delivery through narrow orifices without applying undue pressure.

Instant compositions optionally provide a shear thinning system, such that the apparent viscosity at low shear is quite high, while being lower at high shear. Optionally, the composition creates a yield stress—e.g. the apparent viscosity approaches infinity as the applied shear stress approaches the yield stress value.

Generally, a suspending agent is provided at a concentration that results in a yield stress. Optionally, the suspending agent is selected and provided at a concentration such that a dynamic network is created via physical cross-linking, providing a yield stress. Polymers of the polyacrylic acid-type perform as suspending agents of this type in instant compositions

Optionally, the suspending agent is selected and provided at a concentration such that a dynamic network is created via particle-particle interactions, providing a yield stress. Clays perform as suspending agents of this type in instant compositions,

A suspending agent includes the polymeric type comprising a homo- or copolymer. Optionally, such polymers have dissociable side groups. Examplary polymers useful as suspending agents in the compositions and methods described herein are the carboxyvinyls, polyacrylamides, polysaccharides, natural gums, clays, polyvinlsulfonates, polyalkylsulfones and polyvinylalcohols or mixtures thereof. A suspending agent includes the thermally sensitive gelling-type such as polyoxyethylene-polyoxypropylene copolymers (Poloxamer)

Of the polyacrylic acid-type polymers useful as a suspending agent in the compositions and methods described herein are carbomers, including those sold under the trade name CARBOPOL® (Noveon); Carbopol®-type resins, such as Carbopol®, Pemulen® and Noveon®, are polymers of acrylic acid, crosslinked with polyalkenyl ethers or divinyl glycol. Carbopol®-type polymers include swellable microgels. Non-limiting examples of Carbopol® polymers are Carbopol® Ultrez™ 10, Carbopol®Ultrez™ 20, Carbopol® ETD™ 2020 and Carbopol® ETD™ 2001. Other useful examples are the lightly crosslinked Carbopol® polymers 971P NF, 941 NF, and 981 NF. Other useful Carbopol® are 1342 NF, 9343 NF, 5984 NF, 940 NF, 980 NF, and others.

Natural gums useful as a suspending agent in the compositions and methods described herein are xanthan gum, sodium carageenan, sodium alginate, hydroxypropyl guar, gum Arabic (Acacia), and gum Tragacanth Also useful are the Gellan gums (sold under the trade name Kelcogel by C. P. Kelco) especially when prepared by methods appropriate to create fluid gels of the material. Other polymers useful as a suspending agent in the compositions and methods described herein are alkylhydroxycellulose materials, such as KLUCEL®, commercially available from Hercules (Wilmington, Del.). Non-limiting examples of alkylhydroxycelluloses useful in the compositions and methods described herein include sodium carboxymethylcellulose, hydroxyethyl cellulose, hydroxypropyl cellulose, hydroxypropylmethylcellulose, and methylcellulose.

Clays useful as a suspending agent in the compositions and methods described herein are bentonites (R.T. Vanderbilt's Veegum HV) or laponites (Southern Clay Products' Laponite RD). Optionally, a clay is combined with e.g., a cellulosic polymer, a carbomer, a polysaccharide or another water soluble polymer, providing better suspending properties than either one alone.

Desirable concentrations of a suspending agent are those that result in a settling velocity of less than about 200 mm/year or about 20 mm/year or about 2 mm/year or about 0.2 mm/year). Examples of such suspending concentrations are as set forth in Table 2.

TABLE 2

| | | Useful |
|---|---|---|
| | | concentrations |
| Class | Subclass | (% W/W) |
| Carboxyvinyl-type | | 0.1 to 2 |
| | | 0.25 to 1.5 |
| | | 0.3 to 1 |
| Polyacrylic acid | polyoxyethylene- | 3 to 60 |
| | polyoxypropylene copolymers | 5 to 40 |
| | | 10 to 30 |
| | polyalkenyl ethers or divinyl | 0.10 to 2 |
| | glycol. | 0.25 to 1.5 |
| | | 0.3 to 1 |
| | Carbopol Ultrez | 0.1 to 2 |
| | | 0.25 to 1.5 |
| | | 0.3 to 1 |
| Natural gums | Gellan gum | 0.05 to 0.3 |
| | Xanthan gum | 0.5 to 3 |
| Clays | Bentonites (R.T. Vanderbilt's | 0.5 to 5 |
| | Veegum HV) | |
| | Laponites (Southern Clay | 2 to 3 |
| | Products' Laponite RD). | |

### Dispersing Agent

Described herein are methods and compositions having uniform suspension of the particulate material, despite inherent attractive forces of the particulate material; i,e, particle aggregation is unexpectedly retarded.

A dispersing agent includes a surfactant, polymer, random or block co-polymer, or a suspending agent described herein. Optionally, the dispersing agent has a capacity to bind to the particulate material.

In one embodiment, a dispersing agent has two components—a hydrophobic group and a hydrophilic group, and employs an electrosteric stabilizing mechanism in which the hydrophobic group acts as an anchor adsorbed onto the particulate material surface through an acid-base relation, electron donor/acceptor relation, Van der Waals forces, or physical absorption. The hydrophilic group is extended into the carrier medium to keep the dispersing agent soluble. This results in a competition in the dispersing process between the particulate material and the dispersant, the dispersant and the liquid, and the particle and the solvent. The interaction energies between the carrier medium, the particulate material, and the dispersing agent determine the stability of the dispersion.

Typically, surfactants are included at a concentration of about 0% to about 5% of the composition (W/W). Examples of nonionic surfactants are sorbitol fatty acid esters and alkyl polyethoxylates (for example, C₈-C₁₈ (EO)₄₋₅₀). Other useful surfactants are polysorbates (e.g. polysorbate 20 and polysorbate 80).

In one embodiment, the suspending agents in the instant compositions also provide a dispersing action. Optionally, the suspending agent and the dispersing agent in an instant composition is the same agent, thus minimizing the number of ingredients required in an instant composition. Minimizing the number of ingredients reduces the likelihood of adverse reactions in a composition (e.g. upon storage) or an adverse reaction by an animal exposed to such a composition.

A dispersing agent is also meant to include the addition of an alkali or acid in an amount sufficient to create a charge (e.g. zeta potential) on the particulate material such that aggregation is reduced.

Desirable concentrations of a dispersing agent (e.g. a dispersing concentration) are those that prevent the mass average particle size from increasing by more than 50% during the useful storage period of the composition, or optionally prevent the mass of the distribution that is larger than the original upper particle size from increasing by more than 50% (e.g., from 2% to 3%).

Examples of useful dispersing agent and suspending agents are set forth in Table 3.

TABLE 3

| | | |
|---|---|---|
| Surfactant | Anionic | Carboxylate |
| | | Sulfate (& ethoxylated sulfates) |
| | | Sulfonate |
| | Cationic | |
| | Nonionic | Ethoxylated alkylphenols |
| | | (Triton X-100, Tergitol NP-9) |
| | | Ethoxylated alcohols |
| | Zwitterionic | Alkylaminopropionicacids |
| | | Alkylbetains |
| | | Amine oxides |
| Polymeric | Anionic | Polyacrylates (e.g. Darvan C-N, Darvan 7-N,) |
| | | Lignosulfonates |
| | Cationic | Cationic Guar Gum |
| | Nonionic | Polyvinylpyrrolidone/alpha-olefin co-polymers |
| | | (Ganex V series) |
| | | Polyoxyethylene-polyoxypropylene copolymers |
| | Zwitterionic | |

### Polymer Stabilizer.

Where instant compositions comprises a polymeric suspending agent, such compositions optionally comprise a polymeric stabilizer. Without being bound by theory, the inclusion of a polymeric stabilizer such as a chelating agent (e.g. EDTA), prevents multivalent ions from collapsing crosslinked polyacrylic based suspending agents such as the Carbopols. Such chelating agents are also helpful in keeping transition metal ions from catalyzing degradation processes affecting the suspending agent during high temperature sterilization of the composition. Examples of other polymer stabilizers are nitrilotriacetic acid and derivatives.

pH

The pH of instant compositions is adjusted based upon several technical features, e.g. (i) biocompatibility; (2) optimizing charge repulsion between particulate material, (3) pH effects on rheological properties (dependence upon dispersing and suspending agents). Useful pH ranges that meet one or more of the above technical features are about 5 to about 9 or about 6 to about 8 or outside of about 1-2 pH units of the isoelectric point of the particulate material (e.g. for charge stabilization) or as set forth in Table 4.

TABLE 4

| suspending or dispersing agent | Useful pH ranges |
|---|---|
| Clay | 3-11 or |
| | 4 to 9 or |
| | 4 to 8 |
| Polyacrylic acid-type | 5-10 |
| Gums (Xanthan Gum) | 3-11 |
| Cellulosic-type | Depends on type |
| Gellan gum (polysaccharide) | 4-10 |

### Excipients

In addition, the instant compositions optionally comprise one or more excipients to be used to add volume or bulk, to aid the process by which the composition is manufactured, or to add a desirable property (e.g. smell, color, etc). An example of an excipient used in instant compositions is water.

### Rheological Properties of Instant Colloidal Suspensions

Described herein are compositions that unexpectedly are stably suspended yet fluid enough to allow delivery through a small orifice without undue pressure. Through the teaching herein, useful properties are obtained by selection (and amount) of the suspending agent, dispersing agent, pH, etc.

Instant compositions are deliverable by applying a pressure of 0.1 to 7 atmospheres through an orifice of 50 to 1000 micrometers in diameter and delivery from 2 μl to about 1000 μL in a length of time of about 100 msec to about one minute.

One can now determine optimal yield stresses and/or apparent viscosities to maintain the homogeneity of the particulate dispersion under storage conditions as well as the reduced apparent viscosities required at the shear stresses generated under delivery pressures in the delivery device.

### Uses of Instant Colloidal Suspensions: The Readable Code

Compositions described herein are useful for encoding information in a pattern that are recognized remotely. An example of such a pattern is a barcode. However, there many other non-bar patterns that are used to encode information.

Instant compositions are applied to an object in such a manner as to produce a variety of patterns, including images, holograms, two-dimensional representations, and codes, including barcode like patterns. Readable codes have many uses, such as, though not limited to product or product packaging labeling, document or sample identification and tracking, (e.g. tickets, biological samples, mail documents). Thus the compositions described herein are applied to the surface of an object for identification and/or tracking purposes.

In one embodiment, the instant compositions are applied as a readable code on, or in some embodiments, into to any suitable substrate. Examplary substrates are metal, glass, plastic, paper (including base paper, bond paper, construction paper, cover paper, envelope paper including woven envelope paper, craft paper, newsprint, offset paper, packaging papers, mechanical paper, thin papers, paperboard, boxboard and tissue) and paper containing or paper derived products such as though not limited to cardboard, containerboard, chipboard, corrugating medium, cotton fiber, form bond, insulating board, bleached board, wallboard and wet machine board, and paper derived packaging materials, wood, fabric including natural fabrics (e.g. silk, cotton, linen, wool) and non-natural fabrics (e.g. nylon, polyester) and blends thereof, animal skin, fruit, vegetables, cheese, etc.

### Applications of the Instant Colloidal Suspensions

In one embodiment, instant compositions are used to form a barcode through spraying or injecting. An example of spraying is an ink jet sprayer (e.g. of an inkjet printer). Examples of a suitable injector is a microneedle array injector.

In one embodiment, a readable code is made from instant compositions by inkjet printing, injection, spraying, drawing, offset printing, etching & backfilling, printed onto a substrate (e.g. “label” or :sticker”) and then placed on an object. The actual ink ejection method occurs via several processes including pressurized nozzles, electrostatic fields, piezoelectric elements within an ink nozzle, and heaters for vapor phase bubble formation. For example, In one embodiment, ink jet printing is used with instant compositions as a non-impact method of printing that involves ejecting ink from a nozzle onto a surface.

In one embodiment, instant compositions are injected into or within the skin of an animal to form a readable code (e.g. “tattooing”). In one embodiment, tattoos are applied by hand or with the aid of specifically designed devices. Optionally, instant compositions are applied by injection through needles. Optionally, injection is by a motorized instrument having up to 14 round-tip needles performing injections at a rate of 15 to 30,000 times per minute. The instrument injects pigment at 50 to 30,000 times per minute into the skin, at a depth of about 0.2 mm to about 2 mm. Permanent tattoos are applied deeper into the skin, for example into the dermis or muscle. The depth of the application to achieve permanent coding will vary according to the animal to which the tattoo is being applied.

In one embodiment, instant compositions are used to form circuit board components and electronic components including semiconductors, PN-junctions, MOSFET devices, memory devices, capacitive components, insulating components, microwave shielding components, electrical shielding components, and various other electronic component structures utilizing dielectric, ferroelectric piezoelectric, metallic, or pyroelectric materials. In one embodiment, these structures are deposited by various different deposition methods including spraying, printing (inkjet, offset, gravier, etc), and tape casting.

### Applicators for the Instant Compositions

An example of an instant applicator is a device having an injection cartridge with a reservoir containing an instant composition and a plurality of injection needles in communication with the reservoir.

An example of an instant applicator is a device includes a plurality of microneedles for injecting an instant composition into or below the stratum corneum of the skin. The device has housing formed from a top and bottom wall to define a chamber for containing an instant composition. An inlet port is provided in the top wall of the housing for supplying the instant composition to the chamber and directing the composition to the needles or microneedles

Another example of an instant applicator is a device having a reservoir containing an instant composition, a jet orifice, a means for driving the instant composition through the jet orifice, wherein the jet orifice is in communication with the reservoir.

### Methods of Using the Instant Compositions

Instant compositions are useful for remote reading by an interrogating light. In one embodiment, the frequency of interrogating light is between about 1 GHz to about 100 THz; alternatively the range is from about 2 GHz, from about 5 GHz, from about 10 GHz, from about 20 GHz, from about 50 GHz, from about 100 GHz to about 50 THz, to about 40 THz, to about 30 THz, to about 20 THz, to about 10 THz, to about 5 THz, to about 1 THz. Further, In one embodiment, the interrogating light is monochromatic or polychromatic, coherent radiation or non-coherent radiation, microwave radiation, millimeter wave radiation, or centimeter wave radiation.

Other uses of instant compositions include microwave shielding and in printed circuits. Examples of microwave shielding with instant compositions include coating the inside of a box that has a microwave emitter inside it to keep the microwaves from exiting that box. Another example is to cover a chip with instant compositions to keep radiation from the chip from interfering with surrounding electronics.

Printable circuit applications for ferroelectrics and dielectrics include use as a printable capacitor or in anyplace ferroelectrics are used in circuits.

### Optimizing Compositions for an Injector

With the teaching herein, one skilled in the art can now formulate instant compositions to have desired properties based upon the injector to be used and the intended delivery volume, time, and pressure.

The pressure drop, ΔP, along a tube (i.e. injection needle) is related to the shear stress at the wall of the tube, τ_{w}, and the tube's length, L, and inside diameter, d, by

$$Δ P = \frac{4 L {τ}_{w}}{d}$$

Once the shear stress at the wall exceeds the yield stress, the material will flow, but the flow rate will depend on the apparent viscosity of the material at the applied shear stress. The equation above illustrates that the pressure drop required is not only a function of the material, but of the dimensions of the needle as well. Thus there is a co-action among delivery pressure, the particulate suspensions, and the delivery system.

Consider a particulate composition comprised of 16% by volume of NKN powder suspended in a carrier medium containing 5 g/L of the suspending agent Carbopol 971P NF neutralized to a pH between 6.5 and 7.5 with tris(hydroxymethyl)aminomethane and also containing 0.5 g/L of the polymer stabilizer disodium EDTA. The rheology of this composition is such that it has a yield stress of 2.6 Pa, and in the high shear region its apparent viscosity decreases smoothly from 1.28 Pa sec at a shear rate of 100 sec⁻¹ to 0.36 Pa sec at 1,000 sec.⁻¹, to 0.10 Pa sec at 10,000 sec⁻¹, and 0.055 Pa sec at 30,000 sec⁻¹. Using this composition as an example material, the relationship among its rheological properties, the dimensions of the delivery device, the required volumetric flow rate from the device, and the required driving pressure is demonstrated as set forth in Table 5.

TABLE 5

| | Needle | Required | Resulting | Resulting | Required |
|---|---|---|---|---|---|
| Needle | Inside | Flow | Shear Rate | Apparent | Driving |
| Length | Diameter | Rate | at the wall | Viscosity | Pressure |
| (mm) | (μm) | (μL/sec) | (sec.⁻¹) | (Pa sec) | (atm) |
| 10 | 100 | 2 | 26,597 | 0.059 | 6.22 |
| 10 | 150 | 2 | 7,880 | 0.116 | 2.40 |
| 10 | 200 | 2 | 3,325 | 0.186 | 1.22 |
| 10 | 300 | 2 | 985 | 0.363 | 0.47 |
| 10 | 200 | 10 | 16,623 | 0.077 | 2.52 |
| 10 | 300 | 10 | 4,925 | 0.150 | 0.97 |

### Optimizing Particulate Material for Interrogator Wavelength.

For some applications, the interrogating wavelength needs to be low in order to provide adequate penetration. On the other hand, since the readable code elements need to have a diameter approximately one half the wavelength of the radiation used to read the code, too low a frequency results in a code that is too large to be practical for a given use. For example, 300 MHz microwave radiation (wavelength about 1 meter) will readily penetrate animal hide and all contaminants but would require a readable code too large to be useful (e.g. meters in diameter). Surprisingly, it has been discovered that particulate material is formulated that demonstrates the necessary dielectric properties to respond adequately to wavelengths that provide the required penetration and still be useful to form a readable code of appropriate size.

As is readily understood by a person of skill in the art, at different interrogating wavelengths, a particular dielectric material's perturbation to an electric field may change. For example, a dielectric material that is transparent at one interrogating wavelength may become very lossy at another operating band. Thus, the suspension of particles within the dielectric material forming the dielectric code optimizes performance at the particular operating band of interest. The densities of these suspensions are enough to sufficiently alter the refractive and reflection properties of the dielectric material, but not dense enough to render the dielectric material conductive in the operating band.

For instant compositions, In one embodiment, the interrogating wavelength is between about 1 GHz to about 100 THz; alternatively the range is from about 2 GHz, from about 5 GHz, from about 10 GHz, from about 20 GHz, from about 50 GHz, from about 100 GHz to about 50 THz, to about 40 THz, to about 30 THz, to about 20 THz, to about 10 THz, to about 5 THz, to about 1 THz. Further, In one embodiment, the interrogating waves is monochromatic or polychromatic, coherent radiation or non-coherent radiation, microwave radiation, millimeter wave radiation, or centimeter wave radiation.

### EXAMPLARY COMPOSITIONS

The following examples are provided to further illustrate instant compositions and methods described herein and are not provided to limit the scope of the current invention in any way.

### Example 1

### Preparation of Particulate Material

The following teaches methods of preparation of particulate material generally, and methods for preparation of sodium potassium niobate specifically. Potassium carbonate (20.4 g; 0.15 mol), sodium carbonate (15.6 g; 0.15 mol), niobium (V) oxide (77.3 g; 0.3 mol), purchased from Sigma Aldrich and Alfa Aesar, and ethanol (111 mL) were placed in a Nalgene bottle. Zirconia balls (645 g; 0.25 inch diameter) are added and the bottle agitated for 8 hours at room temperature, after which time the balls are removed and the mixture allowed to air dry.

The resulting solid was sieved through an 80 mesh sieve, and the isolated powder heated in an oven for 5 hours at 950° C. The resulting solid, ethanol (111 mL) and Zirconia balls (645 g; 0.25 inch diameter) were then placed into in a Nalgene bottle and agitated for 8 hours at room temperature. The balls were then removed, the mixture allowed to air dry, and the resulting solid was sieved through an 80 mesh sieve. A small sample of the isolated sodium potassium niobate, Na_{0.5}K_{0.5}NbO₃ (NKN), powder was removed and further processed for analysis.

### Example 2

### Preparation of Sodium Potassium Niobate Sample for Analysis

The sodium potassium niobate powder isolated in Example 11 was pressed at 1000 psi, cold iso-static pressed at 45,000 psi and sintered in air at 1050° C. for one hour, to produce a pellet suitable for analysis. The sample had the characteristics shown in Table 5:

TABLE 5

| Dry Weight | | |
|---|---|---|
| Suspended Weight | 0.23 | g |
| Wet Weight | 0.42 | g |
| Liquid Density | 0.817 | g/cc |
| Theoretical Density | 4.51 | g/cc³ |

| | |
|---|---|
| Volume Open Porosity | 0.036 |
| Apparent Volume | 0.195 |
| Bulk Volume | 0.232 |
| % Open Porosity | 0.157 |
| Bulk Density | 1.677 |
| % Open Porosity | 0.157 |
| Bulk Density | 1.677 |
| Volume of closed porosity | 0.109 |
| % Closed Porosity | 0.47 |
| % Theoretical Density | 0.371 |

### Example 3

### Particle Size Analysis of Sodium Potassium Niobate

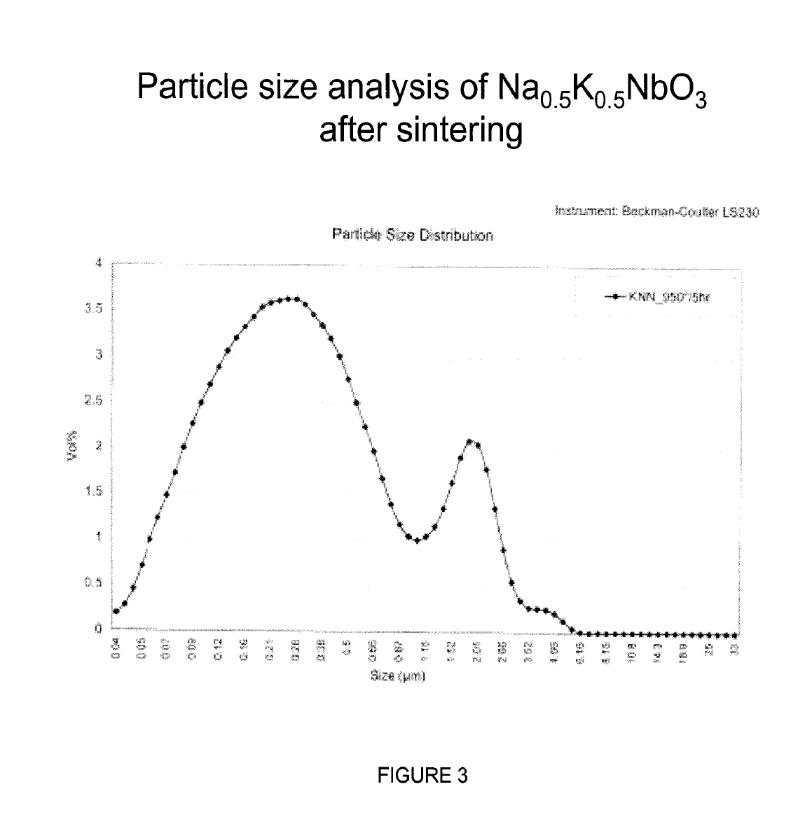

The sodium potassium niobate sample prepared in example 2 was analyzed in a Beckman Coulter LS 230 Laser Diffraction Particle Size Analyzer, using standard operating procedures. Illustrative particle distributions are shown in FIG. 3.

### Example 4

### X-Ray Diffraction Analysis of Sodium Potassium Niobate

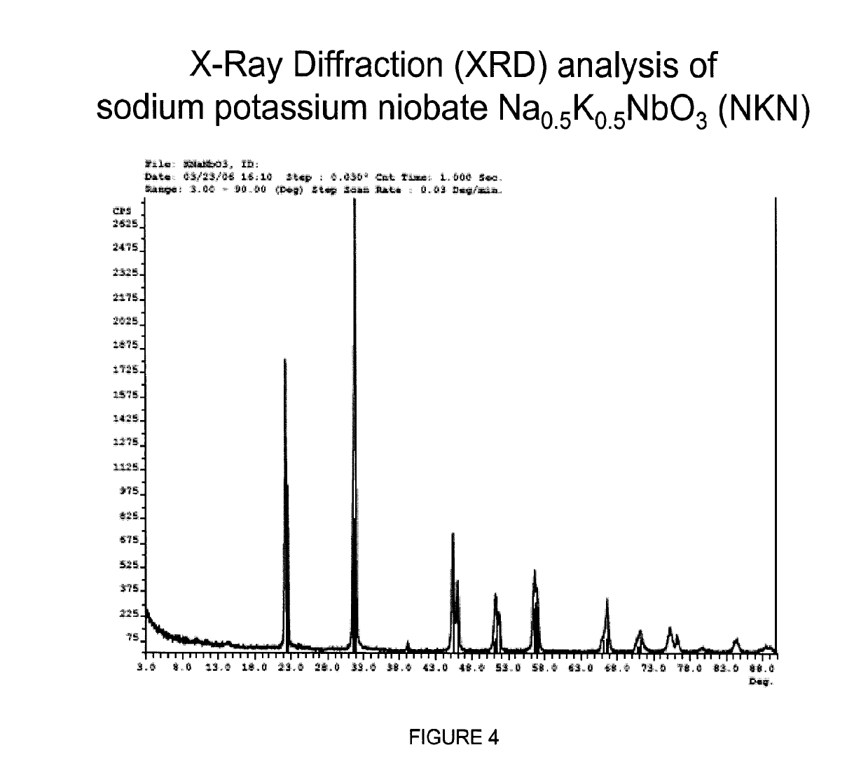

The sodium potassium niobate sample prepared in example 2 was analyzed by X-ray diffraction and the resulting spectrum is shown in FIG. 4.

### Example 5

### Scanning Electron Microscopy of Sodium Potassium Niobate

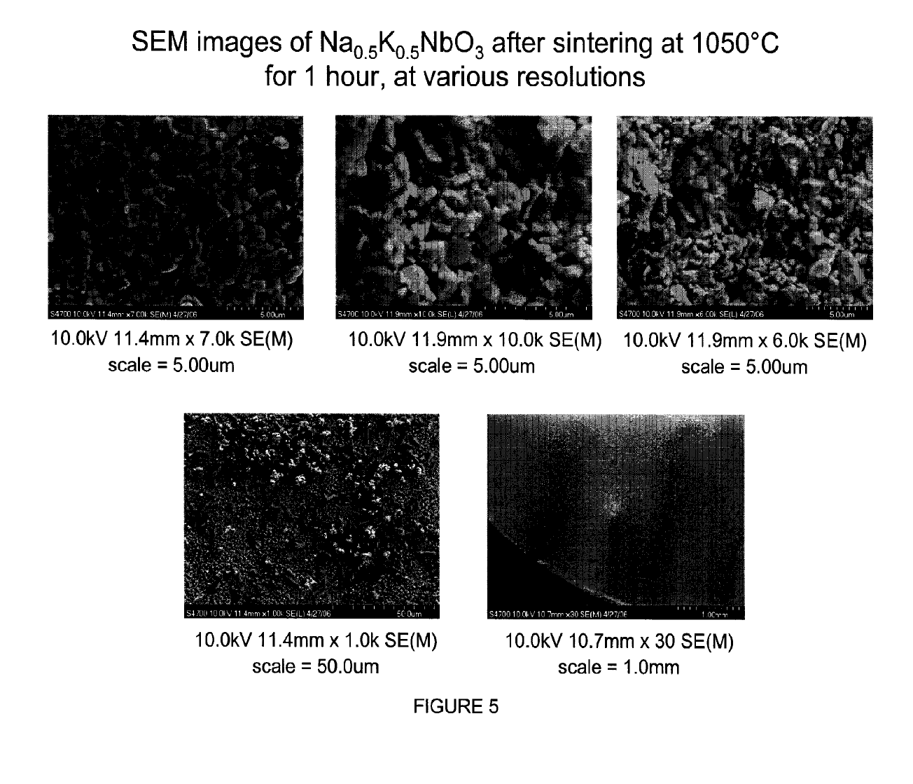

Scanning electron images of the sample prepared in example 2 are recorded and are shown in FIG. 5

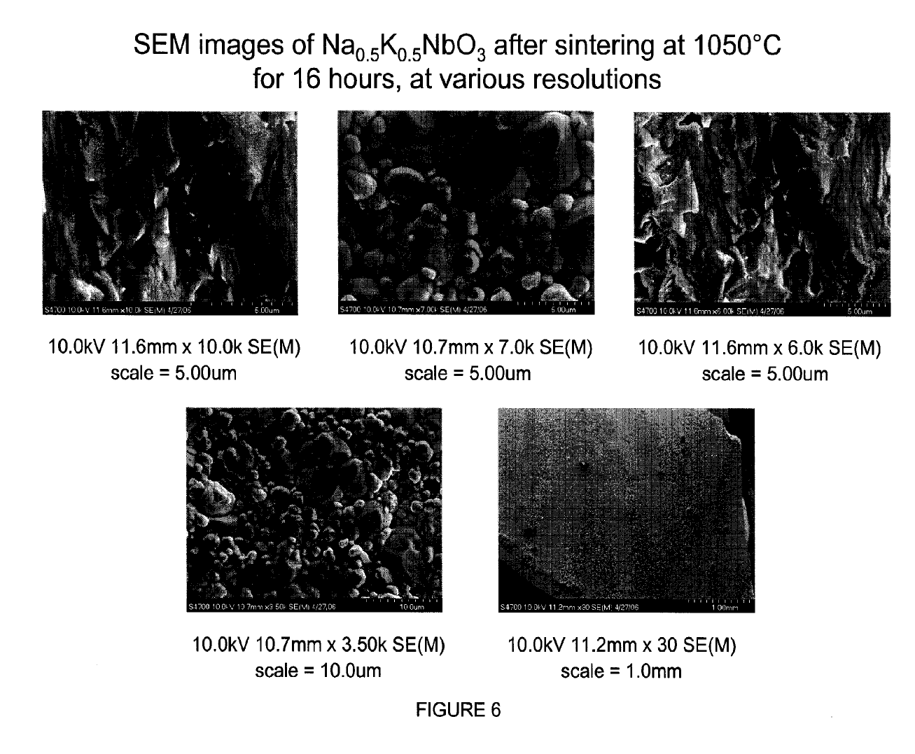

A second sample was prepared as described in Example 2, except sintering was continued for 16 hours. Scanning electron images of this sample are recorded and are shown in FIG. 6.

### Example 6

### Preparation of Composition I

Sodium potassium niobate as prepared in example 1. 55 ml of NKN bulk powder was combined with sufficient deionized water to make up 100 ml of composition. DARVAN® (0.3 g) is added to give a thick viscous suspension. The composition was placed into a container and examined after 8 and 24 hours. No settling out of the solid particulate was observed.

### Example 7

### Preparation of Composition II

Sodium potassium niobate was prepared in Example 1: 55 mls of NKN bulk powder was combined with sufficient deionized water to make up 100 mls of composition. The viscosity of the suspension was adjusted by addition of small amounts of ammonium hydroxide and nitric acid.

### Example 8

### Preparation of Composition III

Sodium potassium niobate was prepared in example 1: 55 mls of NKN bulk powder was combined with sufficient deionized water to make up 100 mls of composition. DARVAN® (0.3 g) and METHOCEL® (0.5 g) were added to give a thick viscous suspension.

### Example 9

### Application of Composition I

A portion of the suspension prepared in Example 6 (composition I) was drawn into an 18 gauge needle and then applied to a sample of simulated skin. The suspension was easily drawn and dispensed and no solid residue remains in the syringe after emptying. The sample was dry after 15-20 minutes.

A portion of the suspension prepared according to Example 6 (composition I) is then applied into the dermal layer of a live cow in a specific pattern. The suspension is easily deposited with the use of a microinjection array. Immediately following injection, the pattern is read by providing a microwave reading signal that is scattered and read by a microwave detection device. Several months after the injection, a second set of successful readings are taken from the tattoo using the method.

### Example 10

### Initial Processing of Particulate Materials

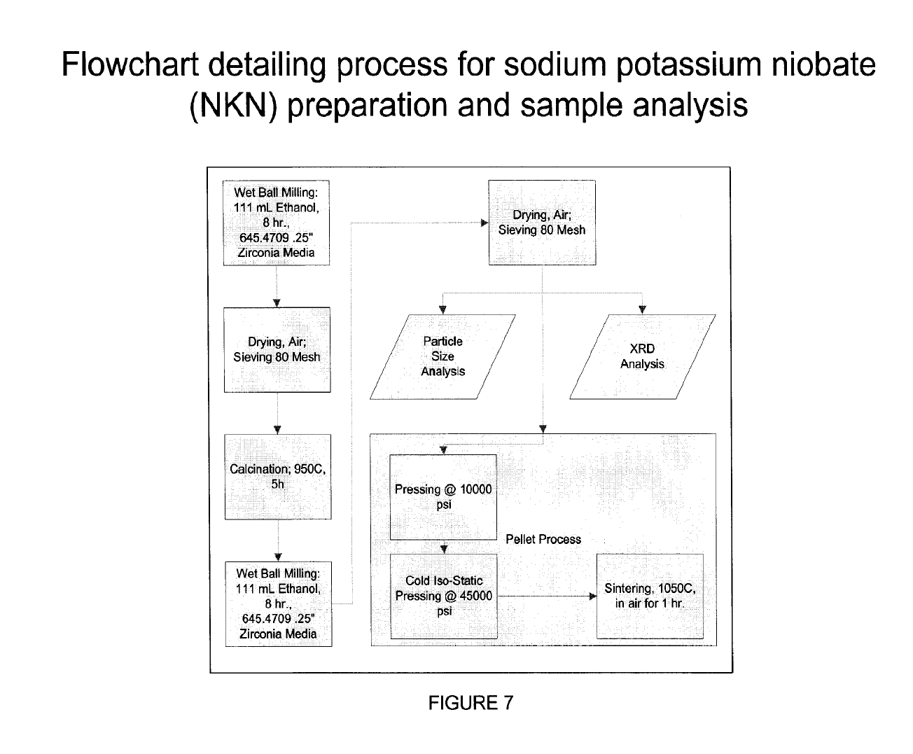

Instant compositions are prepared generally as illustrated for NKN in FIG. 7.

The following procedures describe exemplary production methods for particulate materials. The example uses NKN; however, as noted throughout this disclosure, the instant compositions are formulated with a variety of particulate materials, provided that they have one or more desirable technical features taught herein.

In a first step the starting materials are processed to produce fine particulate matter, suitable for calcining. Typically, this process involves milling the solids, followed by sieving. Many milling techniques and apparatus are available. Materials can be wet or dry milled, i.e. in the presence or absence of a suitable lubricating liquid. Non-limiting examples of milling apparatus include a pestle and mortar or ball mills. Ball mills, also known as centrifugal or planetary mills, are devices used to rapidly grind materials to colloidal fineness by developing high grinding energy via centrifugal and/or planetary action. Suitable materials for use as milling balls include but are not limited to stainless steel, chrome steel, ceramics (such as alumina oxide, sapphire, zirconia), brass, bronze, alloys, copper, cobalt, agate, sintered corundum, tungsten carbide, zirconium oxide, polyamide plastic and the like. The exact type of bowl and balls that are used depend on the type of material being ground. For example, very hard samples might require tungsten carbide balls in steel bowls. As with any method of grinding, cross contamination of the sample with the grinding unit material can be a complication. Many milling machines are available, such as those available from Paul O. Abbé (Bensenville, Ill.), or Dymatron Inc., (Cincinnati, Ohio)

Thus, in some embodiments, a suspension of sodium carbonate (Na2CO3), potassium carbonate (K2CO3) and niobium (V) oxide (Nb2O5 or niobium pentoxide) was prepared, by mixing the three solids, as powders, with a liquid in which they are insoluble. Optionaly, the molar ratios of the solid components are 1:1:2, respectively. The suspension of the solids typically are in an unreactive liquid medium in which the solids are insoluble. Typically, the liquid used is an alcohol, most preferably ethanol. The weight ratio of solids to liquid should be in the range 0.5:2 to about 2:0.5.

Grinding balls are then added to the suspension. As described above, many types of milling balls of various sizes are available. The properties of the balls should be that they are of sufficient hardness to efficiently mill the solids and be unreactive towards the solids, the liquid medium and the vessel containing them. Of particular interest are zirconia balls. For efficient milling, In one embodiment, balls of about 0.1 to about 0.5 inches in diameter are used. In one embodiment, the weight ratio of combined solid starting materials with liquid media to grinding media are about 3:1, respectively.

The milling balls and suspension are placed into a suitable container which is then closed. Suitable containers would include plastic or metal containers with removable, tight fitting closures. In one embodiment, the container is specifically designed for use in milling or is any container that withstands the chemical and physical requirements of the described system. The container is agitated (e.g. shaken, vibrated or rotated) until such time as the particles are considered to be of the desirable size. Typically, this process will be complete within about 8 hours.

The milling balls are then removed and the suspension is dried. This is achieved by any conventional drying procedure, such as though not limited to, leaving the suspension open to the air. In one embodiment, other drying means (e.g. mild heat, reduced pressure, pressurized gas) are also used.

The remaining solid is then sieved through a mesh sieve, of at least 80 mesh size (i.e. at least 80 wires in the mesh per linear inch), to produce the starting materials as fine solid particulates.

### Example 11

### Calcining

In some embodiments, calcining (i.e. the process of heating a substance to a high temperature, to bring about thermal decomposition or a phase transition in its physical or chemical constitution) is desirable. Importantly, one or more of the following outcomes are achieved and contribute to superior properties of instant compositions:
to remove water, present as absorbed moisture, water of crystallization, or as “water of constitution” (e.g. conversion of ferric hydroxide to ferric oxide);
to remove carbon dioxide, sulfur dioxide, or other volatile constituents;
oxidation of a part or the whole of the substance;
reduction of a part or the whole of the substance, e.g. of metals from their ores (smelting)

The calcining of the process currently described involves removal of carbon dioxide, according to the following equation:

Na₂CO₃+K₂CO₃+2Nb₂O₅→4(Na_{0.5}K_{0.5})NbO₃2CO₂

Many methods and apparatus are available to provide the high temperatures typically required for calcining, such as though not limited to kilns, ovens or crucibles, employing fire, electrical or gas heating. In one embodiment, the heating occurs in the open air or under an inert atmosphere. The heating, should at a temperature and for a length of time determined to be required for full conversion of the starting materials into NKN, while making sure that no undesirable reactions (e.g. decomposition) of either the starting materials or the final product take place. In one embodiment, the powdered starting materials, prepared as described above, are placed into an oven and heated to at least 900° C. for at least 30 minutes.

### Example 12

### Preparation of NKN Particles

The size of the particulate material was produced advantageously according the particular use or method of application. In one embodiment the NKN particles had an average diameter of from about 500 nm to about 5 μm. Thus the NKN produced by the procedure described above may require further processing to produce particles of the desired size. In one embodiment, the solid prepared as described above, are milled, dried and/or sieved, by any of the procedures described above, or by any equivalent means to produce NKN particles having an average diameter of from about 500 nm to about 5 μm.

The compositions described in Example 13 thorough Example 29 demonstrate one or more superior properties of instant compositions. For example, these examples are compositions that effectively disperse the particulate material in the compositions and prevent them from settling to the bottom of the container and forming a hard, difficult to redisperse sediment. Thus, in one embodiment are compositions in which the particulate material does not settle or settles only an insignificant distance over the desired storage life of the product, and yet flows with a low apparent viscosity on use with no shaking required before use.

The ability to be used in an injection system was tested requiring that at least 1 mL of the material would flow through a 23-gauge needle with a length of 40 mm under less than 90 psi of pressure.

### Example 13

A composition was made to contain NKN at 8% (VAT) and carrier medium at 92% (V/V) as set forth in Table 6.

TABLE 6

| Carrier Medium Component | (g/L) | |
|---|---|---|
| Carbopol 971P NF | 1.00 | suspending agent |
| tris(hydroxymethyl)aminomethane | 1.30 | pH |
| | | adjustment/neutralizer |
| diazolidynyl urea | 1.50 | |
| methylparaben | 0.55 | |
| propylparaben | 0.15 | |
| propylene glycol | 2.80 | |
| water | q.s. to 1 | |
| | liter* | |

*q.s. to 1 liter = sufficient quantity to make up 1 liter

This composition provided the required low apparent viscosity at high shear rates and does prevent the formation of a hard sediment. With a yield stress of less than 0.1 Pa, some compression was noted. Thus, about 30% of the sample volume was a clear liquid layer on top. This composition has properties that allow for shaking or mixing before use.

### Example 14

A composition was made to contain NKN at 8% (V/V) and carrier medium at 92% (V/V) as set forth in Table 7.

TABLE 7

| Carrier medium Component | g/L | |
|---|---|---|
| Carbopol 971P NF | 2.00 | suspending agent |
| tris(hydroxymethyl)aminomethane | 2.60 | pH adjustment/neutralizer |
| diazolidynyl urea | 1.50 | |
| methylparaben | 0.55 | |
| propylparaben | 0.15 | |
| propylene glycol | 2.80 | |
| Water | q.s. to 1 | |
| | liter | |

This composition provided a low apparent viscosity of 0.018 Pa seconds at a shear rate of 10,000 seconds, yet prevented the formation of a hard sediment. Compression was less than the composition of Example 13.

Its yield stress was still less than 0.1 Pa, allowing the gel to compress to about 93% of the complete sample volume. Thus, about 7% of the sample volume was a clear liquid layer on top. This composition has properties that allow for shaking or mixing before use yet, depending upon the time in storage, such shaking is not necessary.

### Example 15

A composition was made to contain NKN at 8% (V/V) and carrier medium at 92% (V/V) as set forth in Table 8.

TABLE 8

| Carrier medium Component | g/L | |
|---|---|---|
| Carbopol 971P NF | 2.50 | suspending agent |
| tris(hydroxymethyl)aminomethane | 3.25 | pH adjustment/neutralizer |
| diazolidynyl urea | 1.50 | |
| methylparaben | 0.55 | |
| propylparaben | 0.15 | |
| propylene glycol | 2.80 | |
| Water | q.s. to | |
| | 1 liter | |

This composition provided a low apparent viscosity of 0.028 Pa seconds at a shear rate of 10,000 seconds, and with a yield stress of about 0.6 Pa, was able to limit compression of the gel, leaving less than 5% of the sample volume in the clear liquid layer on top. This composition does not require any shaking or mixing before use.

### Example 16

A composition was made to contain NKN at 8% (V/V) and carrier medium at 92% (V/V) as set forth in Table 9.

TABLE 9

| Carrier medium Component | g/L | |
|---|---|---|
| Carbopol 971P NF | 3.00 | suspending agent |
| tris(hydroxymethyl)aminomethane | 3.90 | pH adjustment/neutralizer |
| disodium EDTA | 0.50 | Polymer stabilizer |
| diazolidynyl urea | 1.50 | |
| methylparaben | 0.55 | |
| propylparaben | 0.15 | |
| propylene glycol | 2.80 | |
| Water | q.s. to | |
| | 1 liter | |

The composition of Example 16 provides a low apparent viscosity of 0.037 Pa seconds at a shear rate of 10,000 seconds, and its yield stress of about 1.3 Pa, completely eliminates any compression of the gel, leaving no clear liquid layer on top. This composition will not require any shaking or mixing before use. Even after three freeze/thaw cycles, this composition passed the 23-gauge needle flow test described above.

This composition demonstrates the unexpected advantage of adding a polymer stabilizer such as EDTA when the suspending agent is of the polymeric type. In this case, the polymer stabilizer was 0.5 g/L of disodium EDTA, a chelating agent, to help prevent any multivalent cation contaminants from slowly collapsing the polyacrylic acid suspending agent over time.

### Example 17

A composition was made to contain NKN at 8% (V/V) and carrier medium at 92% (V/V) as set forth in Table 10.

TABLE 10

| Carrier medium Component | g/L | |
|---|---|---|
| Carbopol 971P NF | 5.00 | suspending agent |
| tris(hydroxymethyl)aminomethane | 6.50 | pH adjustment/neutralizer |
| disodium EDTA | 0.50 | Polymer stabilizer |
| diazolidynyl urea | 1.50 | |
| methylparaben | 0.55 | |
| propylparaben | 0.15 | |
| propylene glycol | 2.80 | |
| Water | q.s. to | |
| | 1 liter | |

The Example 17 composition provides an apparent viscosity of 0.072 Pa seconds at a shear rate of 10,000 seconds. Its yield stress of about 2.7 Pa eliminates compression of the gel, leaving no clear liquid layer on top. This composition will not require any shaking or mixing before use, but easily passes the 23-gauge needle flow test both before and after a freeze/thaw challenge. At 5 g/L of this suspending agent, the low shear viscosity is higher than in the composition of Example 16

Table 11 demonstrates favorable properties of compositions with polyacrylic-type suspending agents as exemplified in Example 13 through Example 17 made with 8% (V/V) of particulate material.

TABLE 11

| | | | | Viscosity | Clear Liquid | | |
|---|---|---|---|---|---|---|---|
| | Carbopol | Disodium | Yield | at 10,000 sec-1 | Layer | Needle | Freeze/ |
| | 971P | EDTA | Stress | (Pa | (% of total | Flow | Thaw |
| Example | (g/L) | (g/L) | (Pa) | sec) | volume) | Test | Test |
| Example 13 | 1.0 | 0.0 | <0.1 | — | 30 | Passed | — |
| Example 14 | 2.0 | 0.0 | <0.1 | 0.018 | 7 | Passed | — |
| Example 15 | 2.5 | 0.0 | 0.6 | 0.028 | 5 | Passed | — |
| Example 16 | 3.0 | 0.5 | 1.3 | 0.037 | 0 | Passed | Passed |
| Example 17 | 5.0 | 0.5 | 2.7 | 0.072 | 0 | Passed | Passed |

### Example 18

A composition was made to contain NKN at 4% (V/V) and carrier medium at 96% (V/V) as set forth in Table 12.

TABLE 12

| Carrier medium Component | g/L | |
|---|---|---|
| Carbopol 971P NF | 2.50 | suspending agent |
| tris(hydroxymethyl)-aminomethane | 3.25 | pH adjustment/neutralizer |
| disodium EDTA | 0.00 | Polymer stabilizer |
| diazolidynyl urea | 1.50 | |
| methylparaben | 0.55 | |
| propylparaben | 0.15 | |
| propylene glycol | 2.80 | |
| Water | q.s. to | |
| | 1 liter | |

This composition contains a polymer stabilizer and 4% NKN (V/V) and demonstrates property similar to the composition of Example 15. With a yield stress of about 0.6 Pa, it was able to limit compression of the gel, leaving only about 5% of the sample volume in the clear liquid layer on top. As with Example 15, the minimal compression makes it suitable for use without shaking depending upon period of storage.

### Example 19

A composition was made to contain NKN at 4% (V/V) and carrier medium at 96% (V/V) as set forth in Table 13.

TABLE 13

| Carrier medium Component | g/L | |
|---|---|---|
| Carbopol 971P NF | 2.50 | suspending agent |
| tris(hydroxymethyl)aminomethane | 3.25 | pH |
| | | adjustment/neutralizer |
| disodium EDTA | 1.00 | Polymer stabilizer |
| diazolidynyl urea | 1.50 | |
| methylparaben | 0.55 | |
| propylparaben | 0.15 | |
| propylene glycol | 2.80 | |
| Water | q.s. to 1 liter | |

In Example 19, 1 g/L of disodium EDTA has been added as a polymer stabilizer. Without being bound by theory, the inventors believe that the EDTA chelates multivalent cationic contaminants and prevents them from slowly collapsing the polyacrylic acid suspending agent over time. An undesirable side effect of this addition is that it increases the ionic strength of the carrier medium, which decreases the performance of the Carbopol 971P. The addition decreases the yield stress from about 0.6 Pa to about 0.3 Pa, which reduces the compositions ability to limit the compression of the gel. The result was the formation of a clear liquid layer that was 10% of the sample volume.

### Example 20

A composition was made to contain NKN at 8% (V/V) and carrier medium at 92% (V/V) as set forth in Table 14.

TABLE 14

| Carrier medium Component | g/L | |
|---|---|---|
| Carbopol 971P NF | 2.50 | suspending agent |
| tris(hydroxymethyl)aminomethane | 3.25 | pH adjustment/neutralizer |
| disodium EDTA | 1.00 | chelating agent |
| diazolidynyl urea | 1.50 | |
| methylparaben | 0.55 | |
| propylparaben | 0.15 | |
| propylene glycol | 2.80 | |
| Water | q.s. to | |
| | 1 liter | |

This composition is similar to that of Example 15 but with 1 g/L of disodium EDTA added. The reduction in the yield stress from about 0.6 Pa to about 0.3 Pa results was the formation of a clear liquid layer that was 15% of the sample volume. The higher density of the composition at 8 vol % NKN causes a slightly greater compression of the gel in this case. This composition will require shaking or mixing before use.

The effect of the disodium EDTA on the performance of the Carbopol 971P in compositions with 4% and 8% NKN (V/V) is summarized in Table 15. We have found, as suggested in Example 16 and Example 17, that 0.5 g/L of the disodium EDTA provides desirable properties for the compositions containing polyacrylic acid based suspending agents.

TABLE 15

| | Particulate | | Disodium | Yield | Clear Liquid |
|---|---|---|---|---|---|
| | Material | Carbopol | EDTA | Stress | Layer |
| Example | (V/V) | 971P (g/L) | (g/L) | (Pa) | (% V/V) |
| Example 18 | 4 | 2.5 | 0.0 | 0.6 | 5 |
| Example 19 | 4 | 2.5 | 1.0 | 0.3 | 10 |
| Example 15 | 8 | 2.5 | 0.0 | 0.6 | 5 |
| Example 20 | 8 | 2.5 | 1.0 | 0.3 | 15 |

### Example 21

A composition was made to contain NKN at 14% (V/V) and carrier medium at 86% (V/V) as set forth in Table 16.

TABLE 16

| Carrier medium Component | g/L | |
|---|---|---|
| Carbopol 971P NF | 5.00 | suspending agent |
| tris(hydroxymethyl)aminomethane | 6.50 | pH adjustment/neutralizer |
| disodium EDTA | 0.50 | Polymer stabilizer |
| diazolidynyl urea | 1.50 | |
| methylparaben | 0.55 | |
| propylparaben | 0.15 | |
| propylene glycol | 2.80 | |
| Water | q.s. to 1 | |
| | liter | |

This composition provides an apparent viscosity of 0.086 Pa seconds at a shear rate of 10,000 seconds. Its yield stress of about 2.7 Pa eliminates compression of the gel, leaving no clear liquid layer on top, despite the higher NKN loading. This composition will not require any shaking or mixing before use. It passed the 23-gauge needle flow test both before and after being subjected to five freeze/thaw cycles. As with Example 17, the 5 g/L concentration of the Carbopol 971P provides a high enough yield stress and exhibits flow behavior in the low shear regime that is less desirable in some handling situations. For example, as the yield stress increases, hold-up on the walls of containers tends to increase as well. At 14 1% (V/V), the NKN loading was still well below the level that might lead to shear-thickening flow, but the high shear viscosity will begin increasing more rapidly beyond this loading.

### Example 22

A composition was made to contain NKN at 8% (VAT) and carrier medium at 92% (VAT) as set forth in Table 17.

TABLE 17

| Carrier medium Components | g/L | |
|---|---|---|
| Carbopol 971P NF | 5.00 | suspending agent |
| tris(hydroxymethyl)aminomethane | 6.50 | pH adjustment/neutralizer |
| Darvan C-N | 1.95 | Dispersing agent |
| Triton X-100 | 0.46 | co-dispersing agent |
| disodium EDTA | 0.50 | Polymer stabilizer |
| diazolidynyl urea | 1.50 | |
| methylparaben | 0.55 | |
| propylparaben | 0.15 | |
| propylene glycol | 2.80 | |
| Water | q.s. to 1 | |
| | liter | |

Optionally, embodiments use pH adjustment (e.g. alkali or acid) as a dispersing agent. Once such examplary dispersing agent is adjusting instant compositions that comprise NKN particles into the range of 5 to 9. The resultant large, negative surface charge creates a stable, dispersed suspension without adding an additional dispersing agent. This high negative surface charge also makes it difficult to adsorb anionic polyelectrolytes onto the surface of the particles due to charge repulsion between the surface and the polyelectrolyte. However, it is useful to use a polyacrylic acid based dispersant with a polyacrylic acid based Carbopol (e.g. 971P) suspending agent.

The optional combination of a nonionic surfactant with an ammonium polyacrylic acid-type suspending agent (e.g. Darvan C-N) enhances adsorption on charged particulate material like NKN at near neutral pH.

Example 22 is a similar composition to Example 16, but with the Triton X-100 and Darvan C-N added as the dispersing and co-dispersing agents. The resulting composition passed the needle flow test both before and following three freeze/thaw cycles. As in Example 16, there was no free liquid observed on the surface of the samples.

### Example 23

Optionally instant compositions are pasteurized. For example, compositions set forth in Example 13 through Example 22 are prepared with Carbopols which are heat-resistant. Pastuerization at 80° C. for 30 seconds does not have a negative affect on the technical features of instant compositions.

### Example 24

A composition was made to contain NKN at 1% (V/V) and carrier medium at 99% (V/V) as set forth in Table 18.

TABLE 18

| Carrier medium Components | g/L | |
|---|---|---|
| Laponite RD | 20.0 | suspending agent |
| 0.1M Aqueous HCl solution | qs to pH 7 to 8.5 | pH adjustment |
| Water | q.s. to 1 liter | |

This composition was created by adding 15 g of deionized water to a vial and adding 0.3 g of the Laponite RD while mixing at 2000 RPM for just over 30 minutes. 0.68 g of the NKN powder was then slowly added to the mixture while stirring was continued for 20 minutes longer. During this period, the pH was adjusted to between 7 and 8 with 0.1M HCl solution. After removing the sample from the stirrer and allowing it to stand, the NKN particles settled to the bottom in about 30 minutes.

To verify that the Laponite RD had been fully activated, it was mixed/sheared again with an IKA T25 unit for 15 minutes longer. The sample was allowed to rest on the bench. After 30 minutes, most of the NKN was again at the bottom of the vial, while the supernatant liquid was quite hazy. NKN particles were slowly stirred back up into the Laponite dispersion by hand with a small spatula. This created a stable suspension of the material. This sample passed the 23-gauge needle flow test and shows no tendency to settle with time. However, following just one freeze/thaw cycle, the suspension was no longer homogeneous, with regions of clear liquid on top and between regions of suspension.

At 400× magnification on the microscope, it appeared that not much has changed, but a number of large aggregates (300 to 500 μm) were observed after the freeze/thaw procedure. Following gentle mixing, however, the composition still passes the 23-gauge needle flow test.

### Example 25

A composition was made to contain NKN at 1% (V/V) and carrier medium at 99% (V/V) as set forth in Table 19.

TABLE 19

| Carrier medium Component | g/L | |
|---|---|---|
| Laponite RD | 30.0 | suspending agent |
| 0.1M Aqueous HCl solution | q.s. to pH 7 to 8.5 | pH adjustment |
| Water | q.s. to 1 liter | |

This composition was created by adding 15 g of deionized water to a vial and adding 0.45 g of the Laponite RD while mixing at 2000 RPM for 30 minutes followed by shearing with the IKA T25 Disperser at 8000 RPM for five minutes. 0.68 g of the NKN powder was then slowly added to the mixture while stirring was continued at 2000 RPM on the overhead mixer for 20 minutes longer. During this period, the pH was adjusted to between 7 and 8 with 0.1M HCl solution. Although the composition appears quite thin, within 5 minutes of sitting on the bench, it was starting to set up. While the 20 g/L Laponite sample of Example 24 sample could not set up fast enough to stop the NKN particles from settling, the 30 g/L version doesn't seem to suffer from this problem. The NKN was trapped by the Laponite RD gel quickly enough to stop any settling of the NKN. Although the sample passed the 23-gauge needle flow test and shows no tendency to settle with time, it also became non-homogeneous following two freeze/thaw cycles, with regions of clear liquid on top and between regions of suspension. At 400× magnification on the microscope, it appeared that not much has changed, but a number of large aggregates (300 to 500 μm) were observed after the freeze/thaw routine. Following gentle mixing, however, the composition still passes the 23-gauge needle flow test.

### Example 26

Another suspending agent that has properties useful for the compositions described herein is gellan gum. Kelcogel CG-LA is a cosmetic grade, low acyl gellan gum product available from C.P. Kelco. The material is capable of producing fluid gels that provide the required yield stress, while exhibiting the necessary low apparent viscosity at high shear rates. A composition is made to contain NKN at 8% (V/V) and carrier medium at 92% (V/V) as set forth in Table 20.

TABLE 20

| Carrier medium Component | g/L | |
|---|---|---|
| Kelcogel CG-LA Gellan Gum | 0.50 to 2.0 | suspending agent |
| Calcium chloride (15% solution) | 5.0 | gelling electrolyte |
| Aqueous HCl or NaOH solution | qs to pH 7 | pH adjustment |
| diazolidynyl urea | 1.50 | |
| methylparaben | 0.55 | |
| propylparaben | 0.15 | |
| propylene glycol | 2.80 | |
| Water | q.s. to 1 liter | |

This composition is prepared by slowly adding the gellan gum powder to the water. The stirring is continued while heating to 80° C. Once a clear solution is attained, the calcium chloride solution is slowly added and the pH is adjusted to 7, if necessary. The stirring is stopped and sample is allowed to slowly return to room temperature. The stirring is then resumed to break up the weak gel that has formed into a smooth homogeneous medium. The NKN powder is then thoroughly blended into the carrier medium, followed by addition of the preservative system. This system is stable up to 115° C. allowing the preservative system to be replaced by a Pasteurization process if a preservative-free composition is desired.

### Example 27

Another suspending agent that has properties appropriate for the compositions described herein is VEEGUM HV available from R.T. Vanderbilt. The material is capable of producing fluid gels that provide the required yield stress, while exhibiting the necessary low apparent viscosity at high shear rates. A composition is made to contain NKN at 8% (V/V) and carrier medium at 92% (V/V) as set forth in Table 21

TABLE 21

| Carrier medium Component | g/L | |
|---|---|---|
| VEEGUM HV | 5 to 30 | suspending agent |
| Sodium chloride | 2.5 | electrolyte |
| Darvan C-N | 1.95 | Dispersing agent |
| Triton X-100 | 0.46 | co-dispersing agent |
| Aqueous HCl or NaOH solution | q.s. to pH 7 | pH adjustment |
| diazolidynyl urea | 1.50 | |
| methylparaben | 0.55 | |
| propylparaben | 0.15 | |
| propylene glycol | 2.80 | |
| Water | q.s. to 1 liter | |

The VEEGUM HV is first hydrated in water at 75° C. to 80° C. while stirring at 2000 RPM for 1 hour. The salt is then added. The NKN powder is dispersed separately with the Darvan C-N and Triton X-100. At room temperature, the NKN dispersion is added to the VEEGUM dispersion, and the pH is adjusted to 7. The preservative system is added last. This composition, without additional components, does not show the desired freeze/thaw stability. Once it is frozen, it will not recover its original suspending properties in full.

### Example 28

Another suspending agent that has properties appropriate for the compositions described herein is xanthan gum, available from R.T. Vanderbilt under the trade name VANZAN NF. The material is capable of producing fluid gels that provide the required yield stress, while exhibiting the necessary low apparent viscosity at high shear rates. A composition is made to contain NKN at 8% (V/V) and carrier medium at 92% (V/V) as set forth in Table 22.

TABLE 22

| Carrier medium Component | g/L | Purpose |
|---|---|---|
| VANZAN NF | 3 to 6 | suspending agent |
| Potassium chloride | 2.5 to 10 | electrolyte |
| Darvan C-N | 1.95 | Dispersing agent |
| Triton X-100 | 0.46 | co-dispersing agent |
| Aqueous HCl or NaOH solution | q.s. to pH 7 | pH adjustment |
| diazolidynyl urea | 1.50 | |
| methylparaben | 0.55 | |
| propylparaben | 0.15 | |
| propylene glycol | 2.80 | |
| Water | q.s. to 1 liter | |

The VANZAN NF is slowly sifted into the water with sufficient stirring to create a vortex. Mixing is continued for at least 60 minutes, until the solution is smooth and uniform. The NKN powder is dispersed separately with the Darvan C-N and Triton X-100. At room temperature, the NKN dispersion is added to the VEEGUM dispersion, and the pH is adjusted to 7. The preservative system is added last. This composition is heat stable and will exhibit good freeze/thaw performance.

### Example 29

Optionally, the suspending agents of Example 27 and Example 28 are combined in a single composition. In some embodiments, such a combination unexpectedly provides superior results—for example, where the combination is more effective than otherwise would be predicted. Optionally, instant compositions comprise synergistic combinations of suspending agents. By way of example, such compositions that are additive or even synergestic are compositions that comprise VEEGUM HV and VANZAN NF xanthan gum where the combination unexpectedly results in a composition that more effectively suspends the particulate material than predicted by the suspending activity of the individual suspending agents. The material is capable of producing the required yield stress, while exhibiting the necessary low apparent viscosity at high shear rates. A composition is made to contain NKN at 8% (V/V) and carrier medium at 92% (V/V) as set forth in Table 23.

TABLE 23

| Carrier medium Component | g/L | Purpose |
|---|---|---|
| VEEGUM HV | 5 to 10 | suspending agent |
| VANZAN NF | 1 to 3 | suspending agent |
| Potassium chloride | 2.5 to 10 | electrolyte |
| Darvan C-N | 1.95 | Dispersing agent |
| Triton X-100 | 0.46 | co-dispersing agent |
| Aqueous HCl or NaOH solution | qs to pH 7 | pH adjustment |
| diazolidynyl urea | 1.50 | |
| methylparaben | 0.55 | |
| propylparaben | 0.15 | |
| propylene glycol | 2.80 | |
| Water | q.s. to 1 liter | |

The VEEGUM HV and VANZAN NF are dry blended and added to the water. The mixture is hydrated at 75° C. to 80° C. while stirring at 2000 RPM for 1 hour. The salt is then added. The NKN powder is dispersed separately with the Darvan C-N and Triton X-100. At room temperature, the NKN dispersion is added to the VEEGUM dispersion, and the pH is adjusted to 7. The preservative system is added last. This composition will provide better freeze/thaw performance than the VEEGUM HV alone.

Compositions are tested for rheological properties. A composition is deemed to have “passed” if it meets the following requirements.
Yield Stress (Pa) of 0.05 to 10
Viscosity, measured at a shear rate of 10,000 sec⁻¹ (Pa sec) of 0.01 to 0.5
Formation of a clear liquid layer upon storage for one month of less than 10% of the total volume
Needle Flow test
Freeze/thaw Test (i.e. maintaining the above specifications after 3 cycles of freeze-thaw.

Compositions, representative of the composition classes set forth in Table 24 are made and, without undue experimentation, pass each of the stringent tests.

TABLE 24

| | | Additional or | Additional or | |
|---|---|---|---|---|
| | | Optional | Optional | |
| | | Suspending and/or | Suspending and/or | |
| | Suspending and/or | dispersing agent | dispersing agent | Disodium EDTA |
| Particulate | dispersing agent | #1 | #2 | Concentration |
| Material | (g/L of carrier | (g/L of carrier | (g/L of carrier | (g/L of carrier |
| (% V/V) | medium) | medium)* | medium)* | medium)* |
| 2-30 | Carbopol 971P | Darvan C-N, | Triton X-100, | 0-1 |
| | or equivalent | Darvan 7-N, | Tergitol NP-9, | |
| | 1-20 | or equivalent. | or equivalent. | |
| | | 0-10 | 0-2 | |
| 2-30 | Laponite RD | Darvan C-N, | Triton X-100, | |
| | 1-30 | Darvan 7-N, | Tergitol NP-9, | |
| | | or equivalent. | or equivalent. | |
| | | 0-10 | 0-2 | |
| 2-30 | VEEGUM HV | Darvan C-N, | Triton X-100, | |
| | 5 to 30 | Darvan 7-N, | Tergitol NP-9, | |
| | | or equivalent. | or equivalent. | |
| | | 0-10 | 0-2 | |
| 2-30 | VANZAN NF | Darvan C-N, | Triton X-100, | |
| | 1 to 6 | Darvan 7-N, | Tergitol NP-9, | |
| | | or equivalent. | or equivalent. | |
| | | 0-10 | 0-2 | |
| 2-30 | VEEGUM HV | Darvan C-N, | Triton X-100, | |
| | 5 to 10 + | Darvan 7-N, | Tergitol NP-9, | |
| | VANZAN NF | or equivalent. | or equivalent. | |
| | 1 to 3 | 0-10 | 0-2 | |
| 2-30 | Gums | Darvan C-N, | Triton X-100, | |
| | 0.30 to 2.0 | Darvan 7-N, | Tergitol NP-9, | |
| | e,g, Kelcogel CG- | or equivalent. | or equivalent. | |
| | LA (Gellan Gum) | 0-10 | 0-2 | |

1. A composition comprising a particulate material suspended in a carrier medium comprising:
(a) a suspending concentration of a suspending agent; optionally about 0.01% to about 10% or about 0.25% to about 1.5% or about 0.25% to about 1% (W/W);
(b) a dispersing concentration of a dispersing agent;
(c) a liquid; and optionally
(d) one or more excipients,
wherein the particulate material:
(i) has a dielectric constant of greater than 35 at one or more frequencies between 10 GHz and 1000 GHz at 37° C.;
(iii) has a mass average diameter of about 200 nm to about 50 μm and optionally where the upper limit is not more than about 100 μm in diameter, and
(iv) is at a concentration of about 1% to about 50%; optionally about 2% to about 30% or about 4% to about 16% (V/V).

2. The composition of claim 1 wherein the composition is biocompatible.

3. The composition of claim 1 further comprising a preservative.

4. The composition of claim 1 wherein the composition has an apparent viscosity of less than about 0.5 Pa second at a shear rate of 10,000 seconds⁻¹, or optionally has as an apparent viscosity of less than about 0.1 Pa seconds at a shear rate of 10,000 seconds⁻¹.

5. The composition of claim 1 wherein the composition has a yield stress of at least 0.05 Pa, or optionally has a yield stress of at least 1 Pa.

6. (canceled)

7. The composition of claim 1 wherein the composition has an apparent viscosity greater than 3 kPa seconds at an applied shear stress of 0.25 Pa or less for 10 μm upper particle size, or optionally, greater than 75 kPa seconds at an applied shear stress of 1.2 Pa or less for a 50 μm upper particle size.

8. The composition of claim 1 wherein the composition has a settling velocity of less than 2 mm/year or optionally less than about 0.2 mm/year.

9. The composition of claim 1 wherein the suspending agent is a polymer and the carrier medium further comprises a polymer stabilizer.

10. The composition of claim 1 wherein the suspending agent comprises a polyacrylic acid-type polymer and wherein the composition further has the technical features of:
(a) a yield stress of at least 0.05 Pa, or optionally has a yield stress of at least 1 Pa;
(b) an apparent viscosity greater than 3 kPa seconds at an applied shear stress of 0.25 Pa or less for 10 μm upper particle size;
(c) an apparent viscosity greater than 3 kPa seconds at an applied shear stress of 0.25 Pa or less for 10 μm upper particle size, or optionally, greater than 75 kPa seconds at an applied shear stress of 1.2 Pa or less for a 50 μm upper particle size; and
(d) a settling velocity of less than 2 mm/year or optionally less than about 0.2 mm/year.

11. The composition of claim 10 wherein the suspending agent further comprises a nonionic surfactant.

12. (canceled)

13. The composition of claim 1 wherein the composition is prepared by pasteurization.

14. The composition of claim 1 wherein the composition can be applied in or on a substrate in a pattern such that the pattern can be remotely read by microwave interrogation.

15. The composition of claim 1 having a pH of about 5 to about 9.

16. (canceled)

17. A method of identifying an object comprising (a) delivering the composition of claim 1 on or in an object, in a spatial manner so as to encode information; (b) providing a signal generation and reception system capable of transmitting an interrogation signal and receiving a return signal; (c) transmitting an interrogation signal; receiving a return signal from the dielectric barcode; and (d) processing the return signal to extract the encoded information.

18. (canceled)

19. The method of claim 1, wherein the particulate material comprises sodium potassium niobate, and wherein the sodium potassium niobate is made by a process comprising the steps:
(a) forming a mixture by contacting:
(i) sodium carbonate;
(ii) potassium carbonate;
(iii) niobium (V) oxide; and
(iv) an alcohol;
(b) ball milling the mixture of step (a);
(c) air drying the mixture of step (b);
(d) sieving the mixture of step (c);
(e) heating the mixture of step (d);
(f) ball milling the mixture of step (e);
(g) air drying the mixture of step (f); and
(h) sieving the mixture of step (g) to isolate particles having an average diameter of from about 500 nm to about 10 μm.

20. A readable code made by applying a composition of claim 1 in or on a substrate in a spatial manner so as to encode information.

21. A method for preparing a biocompatible composition, comprising the steps:
(a) contacting a biocompatible liquid with a biocompatible particulate material;
(b) adding a suspending concentration of a suspending agent;
(c) adding a dispersing concentration of a dispersing agent; and
(d) optionally adding at least one polymer stabilizer;
wherein the biocompatible, microwave-readable particulate material:
(i) has a dielectric constant of greater than 35 at one or more frequencies between 10 GHz and 1000 GHz at 37° C.;
(ii) has a mass average diameter of about 200 nm to about 50 μm and optionally where the upper limit is not more than about 100 μm in diameter, and
(iii) is at a concentration of about 1% to about 50%; optionally about 2% to about 30% or about 4% to about 16% (V/V).

22. (canceled)

23. The method of claim 21, further comprising addition of a base or an acid to adjust the pH of the formulation to between about 5 and about 9.

24. A formulation prepared by the method of claim 21.

25. A surface or object comprising the formulation of claim 1 wherein the formulation is on or within the surface of the object.

26. (canceled)

27. (canceled)

28. (canceled)

29. (canceled)

30. (canceled)

31. (canceled)
